(19) United States
(12) Patent Application Publication
(10) Pub. No.: US 2022/0254264 A1
(43) Pub. Date: Aug. 11, 2022

(54) ONLINE LEARNING SYSTEM BASED ON CLOUD-CLIENT INTEGRATION MULTIMODAL ANALYSIS

(71) Applicant: University of Science and Technology Beijing, Beijing (CN)

(72) Inventors: Lun XIE, Beijing (CN); Mengnan CHEN, Beijing (CN)

(73) Assignee: University of Science and Technology Beijing, Beijing (CN)

(21) Appl. No.: 17/320,251

(22) Filed: May 14, 2021

(30) Foreign Application Priority Data
Feb. 7, 2021 (CN) 202110176980.0

(51) Int. Cl. G09B 5/02; G06N 20/00; G06K 9/00; G06K 9/46

(52) U.S. Cl. CPC G09B 5/02; G06N 20/00; G06K 9/4619; G06K 9/00302; G06K 9/00369

(57) ABSTRACT

An online learning system based on cloud-client integration multimodal analysis includes: an online learning module used for providing an online learning interface for a user and collecting image data, physiological data, posture data and interaction log data during an online learning process of the user; a multimodal data integration decision module used for preprocessing the image data, physiological data and posture data, extracting corresponding features, and making a comprehensive decision in combination with the interaction log data to obtain a current learning state of the user; a cloud-client integration system architecture module used for coordinating use of computing resources of a cloud server and a local client according to usage conditions of the cloud server and the local client, and visually displaying a progress of computing tasks; a system interaction adjustment module used for adjusting the online learning module according to the current learning state of the user.

### CROSS REFERENCE TO THE RELATED APPLICATIONS

This application is based upon and claims priority to Chinese Patent Application No. 202110176980.0 filed on Feb. 7, 2021, the entire contents of which are incorporated herein by reference.

### TECHNICAL FIELD

The present invention relates to the technical field of intelligent services, in particular to an online learning system based on cloud-client integration multimodal analysis.

### BACKGROUND

Online learning has been accepted and developed rapidly with its low cost and flexibility. However, due to the lack of interaction, low real-time data processing and single function, online learning has been unable to achieve the effect of traditional classroom. With the development of multi-functional sensors and the landing of 5G communication technology, online learning based on Internet and big data will have a better experience and update ideas.

Applying big data and artificial intelligence to online learning can not only enhance the interaction, but also realize the learning process. Teachers clearly know the emotional state and listening efficiency of students in this class, and students know when their learning efficiency is not high. At the same time, it also has some problems, that is, the feedback is not immediate enough, the traditional server-centered system architecture cannot be processed in real time due to network delay and high load of the server, and the client knows nothing about the computing power of the server, resulting in task congestion and low execution efficiency. Moreover, the accuracy of a single mode is not high enough, and the network bandwidth required by multi-mode is large, so it is necessary to find the best balance between them.

### SUMMARY

To solve the problems of lack of interaction and low real-time interaction in online learning at present, an online learning system based on cloud-client integration multimodal analysis provides accurate interaction by analyzing data of three modes of online learning, efficient utilization of computing resources by effectively coordinating computing resources of a cloud server and a local client, and corresponding feedback and interaction to customers through multimodal data analysis results, thereby improving online learning experience and learning efficiency and giving teachers and students a more comfortable interactive atmosphere.

To solve the above technical problems, the embodiment of the present invention provides the following solution:

An online learning system based on cloud-client integration multimodal analysis, comprising:

an online learning module configured for providing an online learning interface for a user and collecting image data, physiological data, posture data and interaction log data during an online learning process of the user;

a multimodal data integration decision module configured for preprocessing the collected image data, physiological data and posture data, extracting corresponding features, and making comprehensive decision in combination with the interaction log data to obtain a current learning state of the user;

a cloud-client integration system architecture module configured for coordinating use of computing resources of a cloud server and a local client according to usage conditions thereof, and visually displaying progress of a computing task;

a system interaction adjustment module configured for adjusting the online learning mode according to the current learning state of the user.

Preferably, the online learning module comprises:

an interface unit configured for providing the user with the online learning interface, including user login, analysis result viewing, course materials, teacher-student exchange pages, and performance ranking display;

an acquisition unit configured for acquiring the image data, the physiological data, the posture data and the interaction log data of the user in the online learning process through a sensor group.

Preferably, the image data includes facial image sequence data, which is collected by a camera; the physiological data includes blood volume pulse, skin electricity, heart rate variability, skin temperature and action state, which are collected by a wearable apparatus; and the posture data is collected through a cushion equipped with a pressure sensor.

Preferably, the multimodal data integration decision module comprises:

a model training unit configured for training according to a disclosed data set to obtain feature extraction networks respectively used for the image data, the physiological data and the posture data;

a preprocessing unit configured for preprocessing the collected image data, physiological data and posture data, wherein the preprocessing comprises noise reduction, separation and normalization processing;

a feature extraction unit configured for inputting the preprocessed image data, physiological data and posture data into corresponding feature extraction networks to extract facial expression features of the image data, time domain and frequency domain features of the physiological data and time domain and frequency domain features of the posture data;

a decision-making unit configured for sending the extracted facial expression features, time domain and frequency domain features of the physiological data, and time domain and frequency domain features of the posture data into corresponding trained decision-making models respectively, synthesizing obtained decision-making results and the interaction log data, and judging the current learning state of the user.

Preferably, for the image data, a public expression data set is used for training to obtain an optimal convolutional neural network, and the extracted facial expression features are reduced in data dimension by principal component analysis to obtain effective features;

for the physiological data, a median value, a mean value, a minimum value, a maximum value, a range, a standard deviation and a variance of the physiological data are extracted as the time domain features, and an average value and a standard deviation of spectrum correlation functions are extracted as low-dimensional frequency domain features, high-dimensional features are obtained by a deep belief network trained by a public data set, and effective features are obtained by a data dimension reduction algorithm.

for the posture data, a mean value, a root mean square, a standard deviation, a moving angle and a signal amplitude vector of the posture data are extracted as the time domain features, and a direct current component of FFT is extracted as the frequency domain features, and then effective features are obtained by the data dimension reduction algorithm.

Preferably, in the decision-making unit, a fully connected network is used as a binary decision-making model for the image data, a support vector machine is used as a binary decision-making model for the physiological data, and a hidden Markov model is used as a binary decision-making model for the posture data.

Preferably, if a weight of the image data decision is set to 0.3, a weight of the physiological data decision is set to 0.5, and a weight of the posture data decision is set to 0.2, then a comprehensive decision result =0.3* an image data decision result +0.5* a physiological data decision result +0.2* a posture data decision result.

Preferably, the cloud-client integration system architecture module comprises a resource coordination unit, and the resource coordination unit is configured to:

acquire utilization rates of computing resources of the cloud server and the local client, and compare the utilization rates;

preprocess data at the local client, and then synchronize the data to the cloud server for decision-making when the utilization rate of the computing resources of the cloud server is greater than 80% and the utilization rate of the computing resources of the local client is less than 20%;

directly synchronize original data to the cloud server, and complete preprocessing and decision-making for the data by the cloud server when the utilization rate of the computing resources of the local client is greater than 20%;

wherein, the utilization rate of the computing resources includes a CPU occupancy rate and a memory occupancy rate, and is calculated by: (CPU occupancy rate+memory occupancy rate)/2*100%.

Preferably, the cloud-client integration system architecture module further comprises a visualization unit, and the visualization unit is configured to:

set up a Web server in the cloud server for the user to log in to check learning status and scoring situation of the user, and calculate resource usage in real time by the cloud server; allow a teacher to check students' learning situation after logging in, give scores and suggestions, and make corresponding adjustments to curriculums according to the students' performance.

Preferably, the system interaction adjustment module comprises:

a virtual robot unit configured for selecting corresponding knowledge points from teaching materials according to a course flow, showing the knowledge points to the user in a form of pop-up dialogues, and obtaining overall performance scores of a classroom from a database, which are divided into three grades: high, medium and low, and encouraging the user according to the scores;

a reward unit configured for ranking according to the comprehensive performance of the classroom, rewarding the students with high ranking and encouraging the students with low ranking, and inserting a rest and relaxation period in an original learning process or changing learning resource difficulty for users who are relatively negative or very negative for a long time;

a curriculum adjustment unit configured for adjusting the curriculums according to a learning state and interactive feedback of the user, the learning state including an emotional state and a stress state; keep the course progress and materials unchanged when the user's emotion in the online learning process is positive, a pressure level is stable, and the interaction with the system is stable; and slow down a course playback speed, and replace the course materials with a more detailed version when the user's emotion in the online learning process is negative, the stress level is too high, and the interaction with the system is unstable.

The technical solution provided by the embodiment of the present invention has at least the following beneficial effects:

In the embodiment of the present invention, based on the image data, physiological data, posture data and interaction log data collected in the online learning process, multimodal features in the cognitive process of user interactive learning are extracted and processed in real time, so as to predict the current learning state of the user, including emotional state, stress state and interaction situation, and feedback and adjustment can be made timely. According to the present invention, the idea of cloud integration is added into the whole system architecture, so as to achieve the effects of real-time interaction, network bandwidth resource saving and cloud task transparency, finally realizing the integration of interactive feedback of online learning, and providing a new way and a new mode for the combination of online learning and artificial intelligence technology.

### BRIEF DESCRIPTION OF THE DRAWINGS

In order to explain the technical solution in the embodiments of the present invention more clearly, the drawings used in the description of the embodiments will be briefly introduced below. Obviously, the drawings in the following description are only some embodiments of the present invention, and other drawings can be obtained according to these drawings without paying creative labor.

FIG. 1 is a structural diagram of an online learning system based on cloud-client integration multimodal analysis provided by an embodiment of the present invention;

FIG. 2 is a schematic diagram of the workflow of the online learning system provided by the embodiment of the present invention;

FIG. 3 is a schematic diagram of a system architecture provided by an embodiment of the present invention;

FIG. 4 is a schematic structural diagram of a cloud server provided by an embodiment of the present invention;

FIG. 5 is a schematic structural diagram of a local client provided by an embodiment of the present invention;

FIG. 6 is a flow diagram of a cloud-client integration algorithm provided by an embodiment of the present invention;

FIG. 7 is a schematic diagram of a data processing model provided by an embodiment of the present invention;

FIG. 8 is a schematic diagram of a background management framework provided by an embodiment of the present invention;

FIG. 9 is a schematic diagram of system interaction and response flow provided by an embodiment of the present invention.

### DETAILED DESCRIPTION OF THE EMBODIMENTS

In order to make the object, technical scheme and advantages of the present invention clearer, the embodiments of the present invention will be further described in detail with reference to the accompanying drawings.

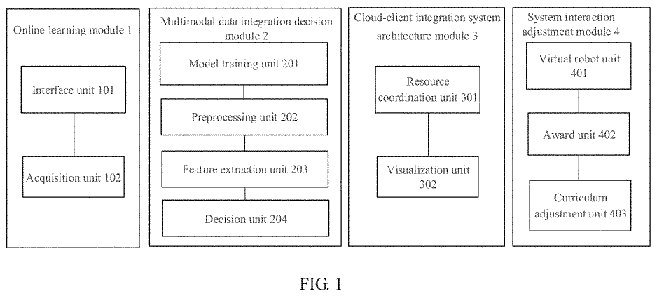

An embodiment of the present invention provides an online learning system based on cloud-client integration multimodal analysis. As shown in FIG. 1, the online learning system includes:

an online learning module 1 used for providing an online learning interface for users and collecting image data, physiological data, posture data and interaction log data during the online learning process of users;

a multimodal data integration decision module 2 used for preprocessing the collected image data, physiological data and posture data, extracting corresponding features, and making comprehensive decision in combination with interaction log data to obtain the current learning state of the user;

a cloud-client integration system architecture module 3 used for coordinating the use of computing resources of the cloud server and the local client according to their usage conditions, and visually displaying the progress of computing tasks;

a system interaction adjustment module 4 used for adjusting the online learning mode according to the current learning state of the user.

In the embodiment of the present invention, based on the image data, physiological data, posture data and interaction log data collected in the online learning process, multimodal features in the cognitive process of user interactive learning are extracted and processed in real time, so as to predict the current learning state of the user, including emotional state, stress state and interaction situation, and make feedback and adjustment timely. According to the present invention, the idea of cloud integration is added into the whole system architecture, so as to achieve the effects of real-time interaction, network bandwidth resource saving and cloud task transparency, finally realizing the integration of interactive feedback of online learning, and providing a new way and a new mode for the combination of online learning and artificial intelligence technology.

Further, the online learning module 1 includes:

an interface unit 101 configured to provide users with an online learning interface, including user login, analysis result viewing, course materials, teacher-student exchange pages, and performance ranking display;

an acquisition unit 102 configured to acquire image data, physiological data, posture data and interaction log data during the online learning process of the user through a sensor group.

Wherein, the image data comprises facial image sequence data, which is collected by a camera; the physiological data includes blood volume pulse, skin electricity, heart rate variability, skin temperature and action state, which are collected by a wearable apparatus; and the posture data is collected through a cushion equipped with a pressure sensor.

As a specific implementation of the present invention, the facial image sequence data can be collected by Logitech C930c 1080P HD camera; the physiological data can be collected through empatica E4 wristband, which mainly collects data such as blood volume pulse, skin electricity, heart rate variability, skin temperature and action state of users in learning state; the user seat cushion is equipped with a pressure sensor produced by Interlink Electronics for collecting attitude data. The collected data is collected by wireless Bluetooth and stored in the local client. During data collection, the graph of the image data and physiological data will be displayed dynamically.

Further, the multimodal data integration decision module 2 includes:

a model training unit 201 used for training according to the public data set to obtain feature extraction networks for image data, physiological data and posture data respectively;

a preprocessing unit 202 used for preprocessing the collected image data, physiological data and posture data, wherein the preprocessing includes noise reduction, separation and normalization;

a feature extraction unit 203 used for inputting the preprocessed image data, physiological data and posture data into corresponding feature extraction networks to extract facial expression features of the image data, time domain and frequency domain features of the physiological data and time domain and frequency domain features of the posture data;

a decision-making unit 204 used for sending the extracted facial expression features, time domain and frequency domain features of the physiological data, and time domain and frequency domain features of the posture data into corresponding trained decision-making models respectively, synthesizing obtained decision-making results and the interaction log data, and judging the current learning state of the user.

For the image data, a public expression data set is used for training to obtain an optimal convolutional neural network, and the extracted facial expression features are reduced in data dimension by principal component analysis to obtain effective features;

for the physiological data, a median value, a mean value, a minimum value, a maximum value, a range, a standard deviation and a variance of the physiological data are extracted as the time domain features, and an average value and a standard deviation of spectrum correlation functions are extracted as low-dimensional frequency domain features, high-dimensional features are obtained by a deep belief network trained by a public data set, and effective features are obtained by a data dimension reduction algorithm.

for the posture data, a mean value, a root mean square, a standard deviation, a moving angle and a signal amplitude vector of the posture data are extracted as the time domain features, and a direct current component of FFT is extracted as the frequency domain features, and then effective features are obtained by the data dimension reduction algorithm.

Further, in the decision-making unit 204, the fully connected network is used as the binary decision-making model for the image data, the support vector machine is used as the binary decision-making model for the physiological data, and the hidden Markov model is used as the binary decision-making model for the posture data.

As a preferred embodiment of the present invention, according to a large number of documents and historical data, different weight values are given to the output results of the three algorithm models. Setting the weight of image data decision as 0.3, physiological data decision as 0.5 and posture data decision as 0.2, the comprehensive decision result =0.3* image data decision result +0.5* physiological data decision result +0.2* posture data decision result.

Among them, according to facial expression features, we can get emotional types including: very positive, relatively positive, calm, relatively negative and very negative; according to physiological characteristics, we can get whether the pressure level is normal; according to posture features, we can divide them into five different sitting positions: correct sitting position (PS), leaning 140(LL) to the left, leaning right (LR), leaning forward (LF) and leaning backward (LB). Interaction log data is used to summarize the interaction frequency and participation degree of users in each class as a part of the final decision. Based on the above indicators, the performance score, stress curve and emotion type of the whole class are given and stored in the database.

Further, the cloud-client integration system architecture module 3 includes a resource coordination unit 301, which is configured to:

acquire utilization rates of computing resources of the cloud server and the local client, and compare the utilization rates;

preprocess data at the local client, and then synchronize the data to the cloud server for decision-making when the utilization rate of the computing resources of the cloud server is greater than 80% and the utilization rate of the computing resources of the local client is less than 20%;

directly synchronize original data to the cloud server, and complete preprocessing and decision-making for the data by the cloud server when the utilization rate of the computing resources of the local client is greater than 20%;

wherein, the utilization rate of the computing resources includes a CPU occupancy rate and a memory occupancy rate, and is calculated by: (CPU occupancy rate+memory occupancy rate)/2*100%.

As a specific implementation of the present invention, when the original data is collected, the system will automatically compare the usage of computing resources between the cloud and the local end, and make intelligent decisions with algorithms, which will lead to two situations. In the first situation, the original data is directly synchronized to the cloud, and the data preprocessing and algorithm model decision-making processes will be carried out in the cloud; in the second situation, complex preprocessing is performed on the original data to obtain the optimal features. When synchronizing to the cloud, the cloud will only run the algorithm model decision-making process.

For example, a crontab timing task is run on the cloud server, the average CPU idle rate and memory idle rate of the server within 6 seconds are recorded and automatically recorded in the database. At the end of a class hour, the local user executes the data automatic synchronization task, obtains the current server computing resources from the database, and obtains the current CPU idle rate and memory idle rate of the local computer by using the psutil module, and compares them. If the server CPU idle rate is less than 20%, the data preprocessing program is run locally, and then synchronized to the cloud server; if the idle rate of local CPU is less than 20%, the original data is directly synchronized, and the cloud server is allowed to complete the preprocessing and subsequent decision-making process.

Further, the cloud-client integration system architecture module 3 further includes a visualization unit 302, which is configured to:

set up a Web server in the cloud server for the user to log in to check learning status and scoring situation of the user, and calculate resource usage in real time by the cloud server; allow a teacher to check students' learning situation after logging in, give scores and suggestions, and make corresponding adjustments to curriculums according to the students' performance.

In addition, the users can decide whether to preprocess or upload directly according to the data of computing resources. Users can transmit the data they want to process, which can be raw data or preprocessed data. The cloud server listener will judge by itself and then input it into the corresponding algorithm model. The webpage can also view the data processing progress, deployed algorithm architecture, etc., so as to realize cloud-to-client transparency.

Further, the system interaction adjustment module 4 includes:

a virtual robot unit configured for selecting corresponding knowledge points from teaching materials according to a course flow, showing the knowledge points to the user in a form of pop-up dialogues, and obtaining overall performance scores of a classroom from a database, which are divided into three grades: high, medium and low, and encouraging the user according to the scores;

a reward unit configured for ranking according to the comprehensive performance of the classroom, rewarding the students with high ranking and encouraging the students with low ranking, and inserting a rest and relaxation period in an original learning process or changing learning resource difficulty for users who are relatively negative or very negative for a long time;

a curriculum adjustment unit configured for adjusting the curriculums according to a learning state and interactive feedback of the user, the learning state including an emotional state and a stress state; keep the course progress and materials unchanged when the user's emotion in the online learning process is positive, a pressure level is stable, and the interaction with the system is stable; and slow down a course playback speed, and replace the course materials with a more detailed version when the user's emotion in the online learning process is negative, the stress level is too high, and the interaction with the system is unstable.

Specifically, the interaction can be divided into three situations: when the overall performance of students is positive or normal, and the stress level is normal, the virtual robot will pop up relevant important knowledge points with normal frequency, and some encouraging sentences will be given to users, and the evaluation ranking of users will appear in the web page ranking system, giving some rewards to outstanding students according to the ranking, so that users can keep positive and learn more efficiently; when it is comprehensively evaluated that students are negative in class and the stress level is normal, the virtual robot switches modes and interacts with a higher frequency to prompt the user. In addition, the system updates more comprehensive learning materials and reduces the workload to reduce students' stress; when students are in negative mood and abnormal stress level, in addition to the above interactive changes, the teacher's interaction is increased, that is, the teacher changes the teaching style and teaching speed according to the students' comprehensive performance displayed in the background of the system, and consults and solicits students with poor comprehensive performance scores, so as to obtain student feedback and improve the learning efficiency of users.

The specific embodiments of the present invention will be described in detail with reference to the accompanying drawings.

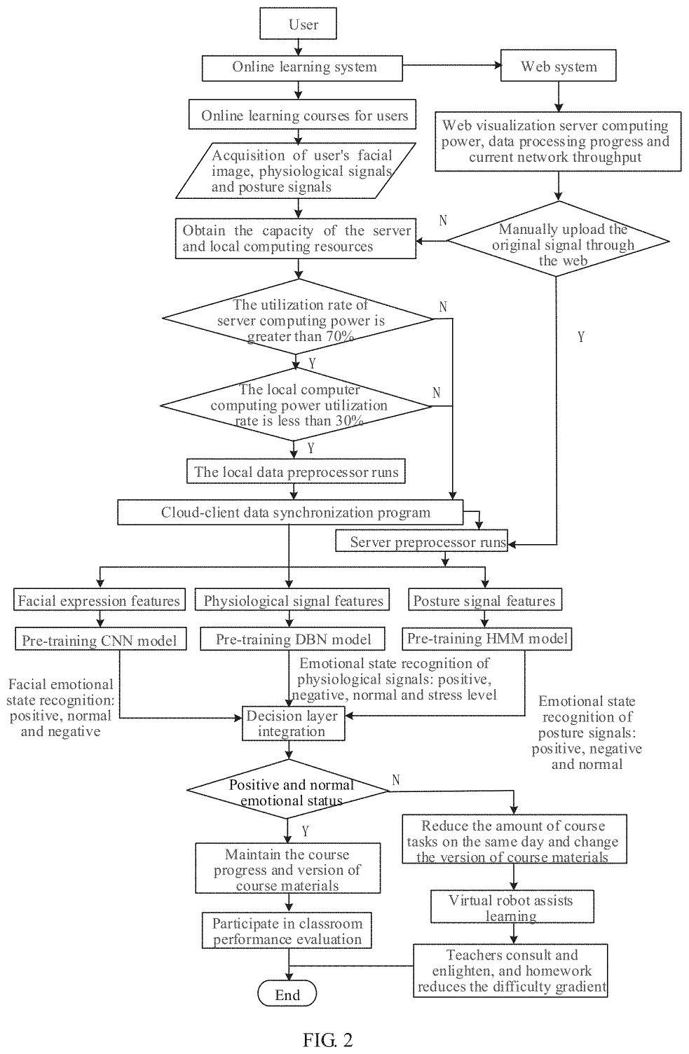

FIG. 2 is a schematic diagram of the workflow of an embodiment of the present invention. First, users log in to the online learning system, and each sensor collects facial image data, physiological signal data and posture signal data during the course of listening to lectures. Users also collect log data during the course of listening to lectures and doing questions. The file management system collects these files and puts them in specific folders. When the course is completed, the user terminal equipment makes uploading and preprocessing decisions according to its own computing resources and the server computing resources recorded in the remote database. When the utilization rate of server computing resources is greater than 80% and the utilization rate of local computing resources is less than 20%, the local data preprocessing program is run, and the output facial expression features, physiological signal features and posture signal features are synchronized to the cloud through the timed cloud-client synchronization program. When the cloud monitors that the data type is preprocessed, it directly sends the data to the computing network to obtain the predicted emotion and stress results. When the utilization rate of local computing resources is greater than 20%, the timed cloud-client synchronization program is directly run to synchronize the original signals to the cloud. When the cloud monitors the original data type, the data is preprocessed and then sent to the computing network, and the emotion and stress prediction results are obtained. In the third case, students don't want to preprocess data with their own devices, so they can choose to upload the collected data files manually on the Web page, and then the server makes preprocessing and calculation decisions after uploading. According to different weights, the current comprehensive decision result =0.5* physiological signal prediction result +0.3 facial expression prediction result +0.2* posture signal prediction result, the pressure is measured by physiological signal to assist decision-making, and the interaction log data can detect whether students are listening to lectures or doing other things with equipment. Among them, the facial expression features can get the following prediction results: positive, normal and negative; the physiological signals can get the following prediction results: positive, negative and normal, whether the pressure level is normal; and the posture signals can get the following prediction results: positive, negative and normal. The predicted learning state results (including emotion, stress, sitting posture, etc.) are saved in the database. When it is predicted that the user is in positive and normal mood during class, the progress of the course will be kept, the version of the course materials will remain unchanged, the virtual robot will automatically pop up relevant knowledge points during the learning process, and the user can participate in the classroom performance evaluation on the same day, and the evaluation results will be displayed on the Web page. On the contrary, when the user's emotion is negative, the online learning system will intelligently reduce the amount of course tasks on the same day, and change the version of course learning materials to make less homework after class and more detailed course related materials. At the same time, the virtual robot will automatically pop up relevant knowledge points and some encouragement and inquiry information in the learning process. Students' classroom performance will appear in the teacher's background management system, and the teacher will make corresponding teaching adjustments according to the students' performance, and offer counseling and condolences to the students who are not performing well.

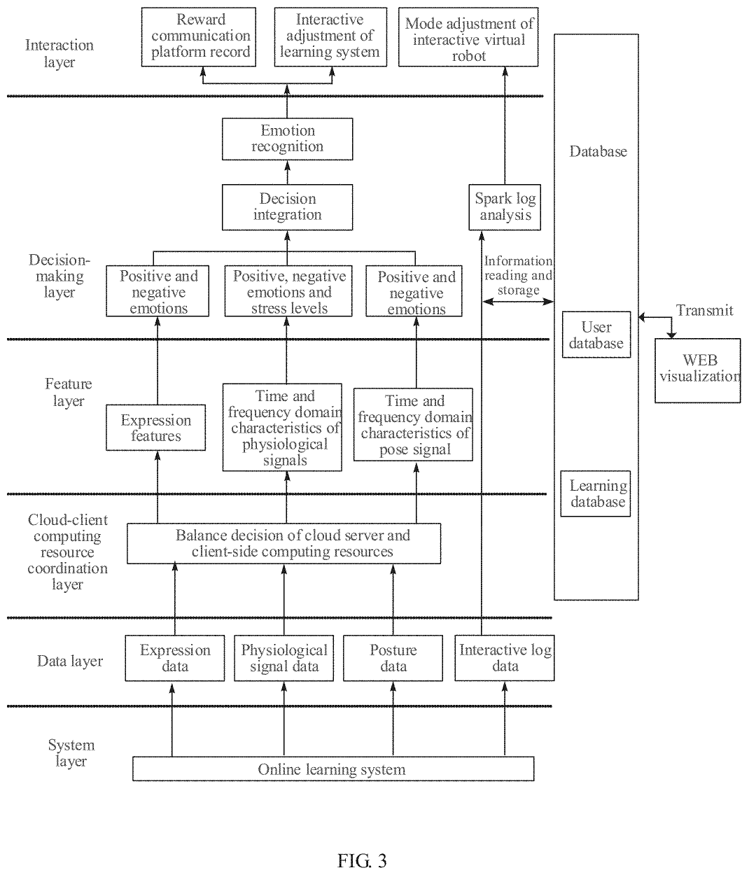

FIG. 3 is a schematic diagram of a system framework according to an embodiment of the present invention. As a specific architecture of the present invention, the online learning system based on cloud-client integration includes a system layer, a data layer, a cloud computing resource coordination layer, a feature policy layer, a decision layer, an emotion layer and an interaction layer.

The system layer is an online learning platform where users register and log in by entering account passwords. The users log in and fill in basic information, and can choose courses online. When they enter personal space, they can check their performance evaluation and ranking during class, and interact with teachers and ask questions.

The data layer is used for collecting facial image data, physiological data, posture data and interaction log data generated by the interaction between the user and the system by the system. The facial image data acquisition module mainly collects facial macro-expression features of users during online learning, and stores the images collected in one minute. Physiological data are various physiological data collected in real time, such as skin electricity, heart rate, body surface temperature, inertial data, etc., which are worn on the wrist of the user, and are also stored in one minute. For the posture data, the sitting posture of the user when learning online is collected, a seat cushion is placed on the stool, and the data are saved separately in one minute. The log data adopts Flume framework to collect a series of behavior data of users interacting with the system in the process of learning and doing problems, which is mainly used to analyze the users' positive degree of courses.

The cloud computing resource coordination layer coordinates and distributes computing resources of the server and the local client, so that the system is decentralized and the load of the cloud server is reduced. When the data is collected, the local client decides to process the data according to its own idle computing resources and the idle computing resources of the server. Customers can obtain the current workload of the server according to the information of Web visualization, and decide whether to upload all the data to the cloud for processing or preprocess the data before uploading. Of course, the system will also make its own decisions The system integrates the cloud computing resource balancing load algorithm, which can automatically preprocess the original data and then synchronize the data when the local computing resources are sufficient; when the cloud server is idle, the original data will be directly synchronized to the cloud, and the cloud will complete the whole process of data processing.

The feature layer includes facial expression features, frequency domain and time domain features of physiological data, and time domain and frequency domain features of posture data. The facial expression features of facial image data are extracted by training a large number of public expression data sets to get the optimal convolution neural network, and the extracted features are reduced by principal component analysis. Feature extraction of the same physiological data includes: firstly, smoothing the original physiological signal with low-pass filter, then normalizing the signal, and extract the systematic time domain features such as median, mean, minimum, maximum, range, standard deviation and variance. Low-dimensional frequency domain features, such as average and standard deviation of spectrum correlation function, getting high-dimensional features through deep belief network pre-trained by public data sets, and then getting effective features through data dimension reduction algorithm. Feature extraction of posture data includes analyzing pressure sensor data and triaxial acceleration sensor data respectively, the obtained features including mean value, root mean square, standard deviation, DC component of principal component analysis (PCA) and fast Fourier transform (FFT) of original data.

The decision-making layer sends the extracted features into the algorithm model trained by the public data set. In the present invention, the full connection network is adopted as the binary classification model of the decision-making layer for image data, the support vector machine is adopted as the binary classification model for physiological data, and the hidden Markov model is adopted as the binary classification model for posture data. The results of the three models are fused at the decision-making level. According to a large number of experiments, it can be set that image data decision-making accounts for 0.3, physiological data decision-making accounts for 0.5, and posture data decision-making accounts for 0.2 in the comprehensive decision. The final recognition result is stored in the database. The interaction log data is analyzed by big data framework spark, which records the students' operation on the system, such as the speed of doing questions, the times of playing back videos, and whether there is cheating behavior. These data are stored in the database and included in the comprehensive investigation conditions of teachers.

The interaction layer is the interaction between the system and users and the interaction between teachers and students. After the user attends class, the system comprehensively evaluates the students' classroom performance according to the emotional prediction in the database, log analysis results and stress level prediction. When the overall performance of students is positive or normal, the system virtual robot will pop up relevant important knowledge points to cheer up the users, and the evaluation ranking of users will appear in the web page ranking system, and give some rewards, so that users can keep their status and learn more efficiently. When the students are judged to be negative in class, the virtual robot switches modes and interacts at a higher frequency. Besides, the system updates more comprehensive learning materials and reduces the workload to reduce the pressure on students. Teacher interaction means that the teacher changes the teaching style and teaching speed according to the students' comprehensive performance displayed in the background of the system, and consults and solicits the students with poor comprehensive performance scores, thereby obtaining the feedback from students and improving the learning efficiency of users.

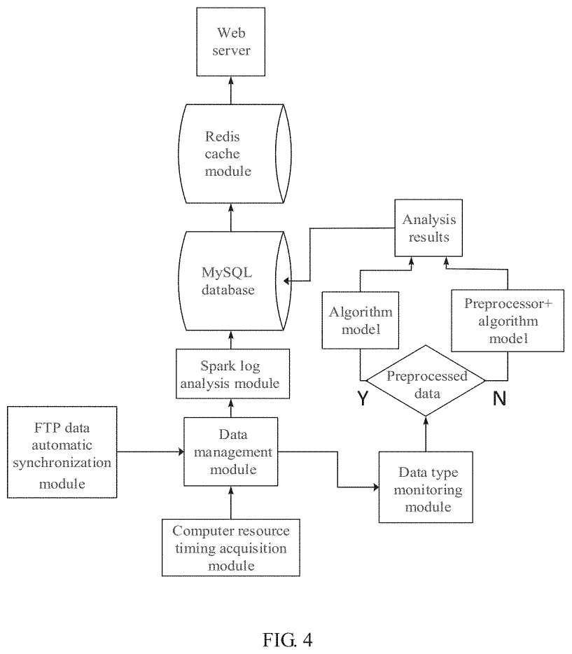

FIG. 4 is a schematic diagram of the deployment of a cloud server according to an embodiment of the present invention. The system modules and functions are as follows: the cloud server uses a built-in timed task module crontab to collect the usage of computing resources of the server within 6 seconds and save them in a database for Web display and user acquisition; a FTP data synchronization module can synchronize the data between cloud and end regularly and avoid uploading duplicate data; a data management module stores the original data and the preprocessed data in a partitioned way; a data type monitoring module judges whether the currently synchronized data is original data or preprocessed data. If it is original data, the data is first input into the preprocessor and then into the algorithm model; if it is preprocessed data, it is directly input into the algorithm network, so the preprocessor and algorithm model should be deployed for data processing. A Spark log analysis module is used to analyze log information, so as to obtain the information that users interact with the system in online learning; a database module is used to store the results of data processing by algorithm model, such as emotion, stress, interactive information, etc. Two databases are used to achieve faster interaction according to database characteristics, all data are stored in MySQL database, and Redis is used to store recent data; The Web server shows the data information in the database to the user, from which the user can obtain the analysis results and the progress information of the server computing resources and data processing tasks.

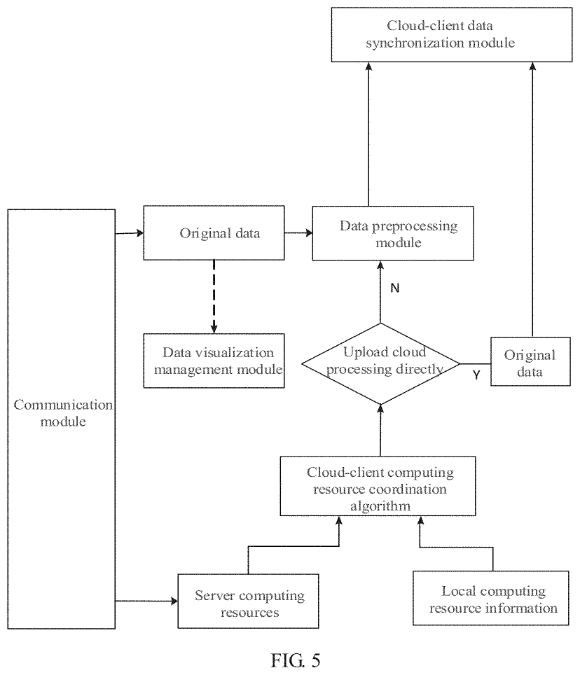

FIG. 5 is a deployment schematic diagram of a local client according to an embodiment of the present invention. The system includes: a cloud computing resource coordination algorithm for realizing coordinated utilization of resources between the cloud and the terminal, making full use of local resources and reduces cloud server load without hindering customers from running and using the system, and decides whether to preprocess original physiological data locally according to cloud computing resources and local computing resource usage; a data visualization module which allows users to visually collect data line charts in real time when receiving data, and this function can be selectively turned on; the communication module includes Bluetooth and network, the Bluetooth communication module is responsible for transmitting the original physiological data, and the network is responsible for exchanging data and communicating with the server. The data preprocessing module is the same as that deployed on the server, which is responsible for directly preprocessing data when the local computing resources are sufficient; the cloud-client synchronization module realizes regular synchronization of file data between the cloud server and the local client.

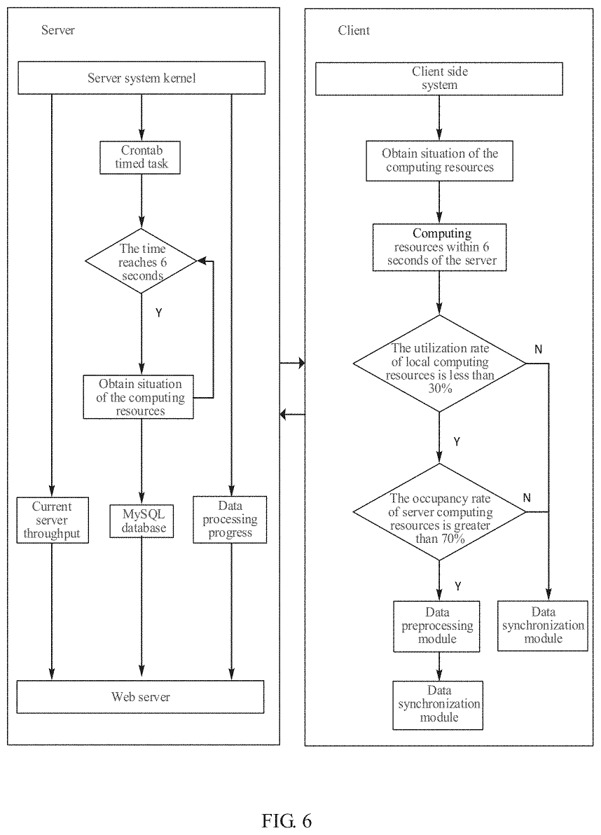

FIG. 6 is a flow chart of cloud-client integration algorithm according to an embodiment of the present invention. The cloud-client integration of the present invention is the flexible allocation and application of the computing resources between the cloud and client. Data processing algorithms at both ends are closely matched and indispensable. The cloud server is transparent to local users, so that the load of computing resources of the cloud server and the data processing progress of the cloud server can be seen. Firstly, crontab on the cloud server side collects the computing resource utilization rate of the server within 6 seconds, records it into the database, calculates the current server throughput and data processing progress, and updates them on the Web server in real time; the local client first obtains utilization rate of its own computing resource, then obtains the computing resource utilization rate of the server side within 6 seconds from the database, and makes decisions according to these two data. When the local computing resource occupancy rate is less than 20% and the server is busy, the data is preprocessed at the local user side and uploaded to the cloud server. If the local computing resource occupancy rate is more than 20%, the original data is directly uploaded to the cloud, and the cloud preprocesses the data.

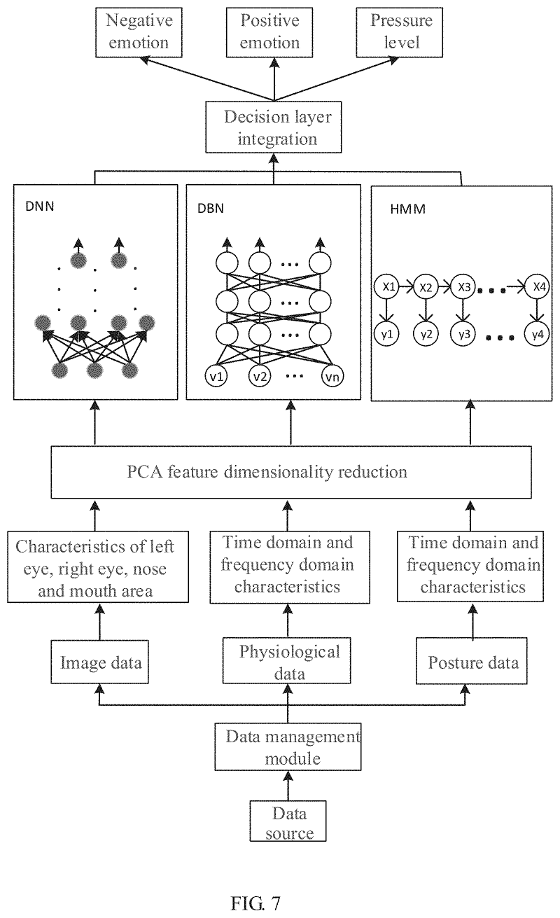

FIG. 7 is a schematic diagram of a data processing model according to an embodiment of the present invention. The model is only configured in the cloud server. When synchronizing from the local client to the cloud server, the data management module divides the data into fixed folders. When the monitoring module finds new data coming, it first determines what kind of data it is, and then uses the corresponding algorithm to remove it. The image data is processed by a feature processing program to obtain regional features such as left eye, right eye, nose and mouth; the physiological data are extracted to obtain time domain and frequency domain features; the posture data are also extracted to obtain time domain and frequency domain features; all features are dimensionalized by principal component analysis (PCA) to obtain effective features, which are respectively input into three corresponding decision networks: Deep Neural Network (DNN), Deep Belief Network (DBN) and Hidden Markov Model (HMM). The final results are obtained by integration of the decision-making layer, and then stored in the database.

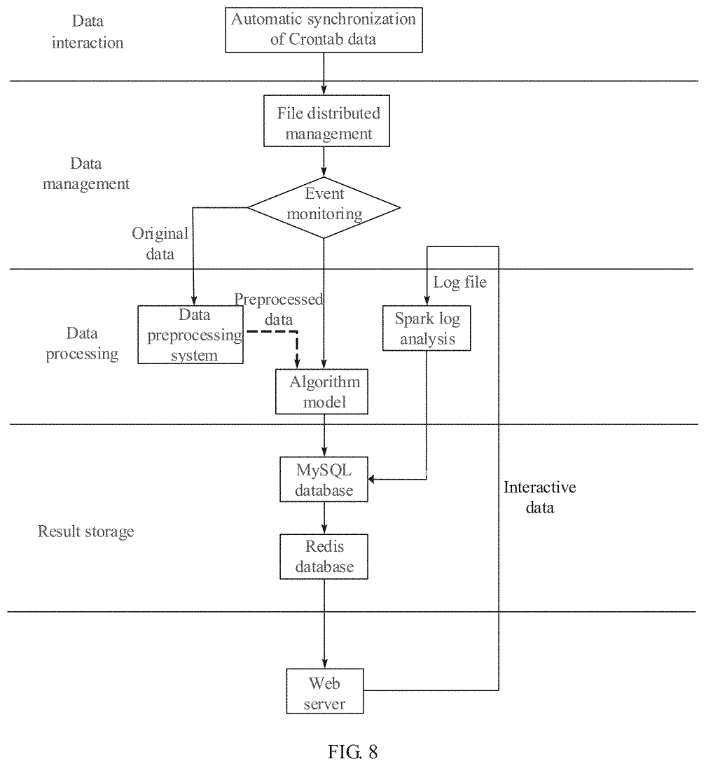

FIG. 8 is a flow chart of a background management system according to an embodiment of the present invention, in which data interaction is timed by a cloud-client automatic synchronization program configured in crontab software; data management includes classifying the received data types and identifying whether the data has been preprocessed. The original data needs to be preprocessed before being sent into the algorithm model, and the preprocessed data is directly input into the algorithm model. The results are stored in the database, and the two types of databases are based on the consideration of security and rapidity. Addition of a redis database can speed up the access speed and maintain the real-time performance of the system; the Web provides a visual interface, and can realize the interaction between users and the system, for example, users can upload the collected data by themselves without system decision, and realize the communication between teachers and students; web pages can collect the interactive data between users and system logs, which can be uploaded via HTTP; the results of spark log analysis are helpful to judge the user status and increase the accuracy.

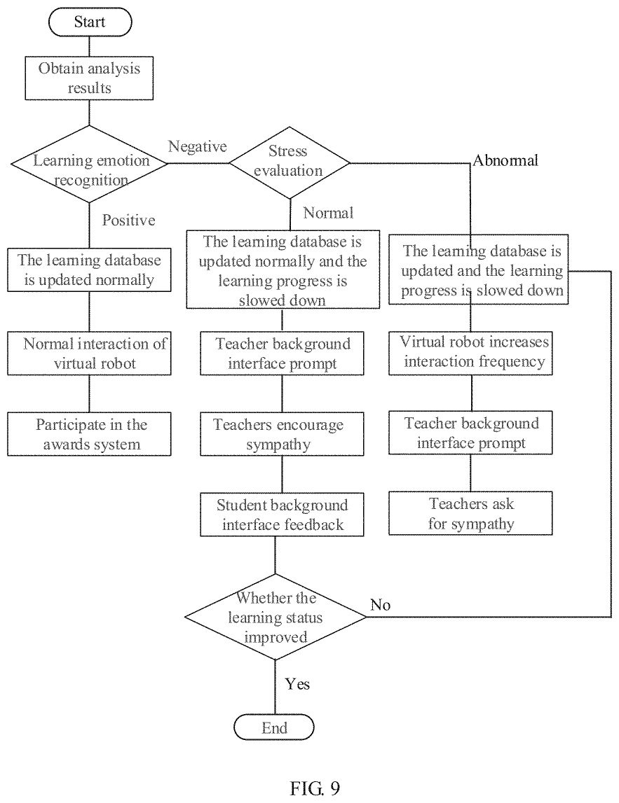

FIG. 9 is an interactive flow chart of an embodiment of the present invention. The system makes corresponding adjustments according to the analysis results of multimodal data. There are two evaluation indexes, namely, emotional state evaluation and stress evaluation. When the emotional state is positive, it means that the user is in a happy state of learning, so that the background system should keep normal learning tasks. Virtual robots help review knowledge points and praise users, and let users participate in classroom performance evaluation to encourage students to keep learning state. When the user's mood is negative, but the stress level is normal, which means that the user is studying hard, but has not kept up with the progress of the course and has little difficulty in learning, then the system will slow down the progress of the study according to the analysis results, and the course tasks will be reduced. According to the background prompts, the teacher will contact the students actively, understand his difficulties and make corresponding adjustments to the course. If it is still not improved, the system will be converted to the third state, that is, the user's mood is negative and the pressure is abnormal. This shows that users are experiencing some persistent difficulties, and the system will make corresponding changes according to this result. First, the learning progress is slowed down and the learning materials are updated to another more detailed version; virtual robots increase the interaction frequency, and teachers call for sympathy and consultation to adjust the students' class status.

The above is only a preferred embodiment of the present invention, and is not intended to limit the present invention. Any modifications, equivalent substitutions, improvement and the like made within the spirit and principles of the present invention shall be included in the scope of protection of the present invention.

What is claimed is:

1. An online learning system based on a cloud-client integration multimodal analysis, comprising:
an online learning module configured for providing an online learning interface for a user and collecting image data, physiological data, posture data and interaction log data during an online learning process of the user;
a multimodal data integration decision module configured for preprocessing the image data, the physiological data and the posture data, extracting corresponding features, and making a comprehensive decision in combination with the interaction log data to obtain a current learning state of the user;
a cloud-client integration system architecture module configured for coordinating use of computing resources of a cloud server and a local client according to usage conditions of the cloud server and the local client, and visually displaying a progress of a computing task;
a system interaction adjustment module configured for adjusting the online learning module according to the current learning state of the user.

2. The online learning system according to claim 1, wherein the online learning module comprises:
an interface unit configured for providing the user with the online learning interface, comprising a user login, an analysis result viewing, course materials, teacher-student exchange pages, and a performance ranking display;
an acquisition unit configured for acquiring the image data, the physiological data, the posture data and the interaction log data of the user in the online learning process through a sensor group.

3. The online learning system according to claim 2, wherein the image data comprises facial image sequence data, wherein the facial image sequence data is collected by a camera; the physiological data comprises a blood volume pulse, a skin electricity, a heart rate variability, a skin temperature and an action state, wherein the blood volume pulse, the skin electricity, the heart rate variability, the skin temperature and the action state are collected by a wearable apparatus; and the posture data is collected through a cushion equipped with a pressure sensor.

4. The online learning system according to claim 1, wherein the multimodal data integration decision module comprises:
a model training unit configured for training according to a disclosed data set to obtain feature extraction networks respectively used for the image data, the physiological data and the posture data;
a preprocessing unit configured for preprocessing the image data, the physiological data and the posture data to obtain preprocessed image data, preprocessed physiological data and preprocessed posture data, wherein the preprocessing comprises a noise reduction, a separation and a normalization processing;
a feature extraction unit configured for correspondingly inputting the preprocessed image data, the preprocessed physiological data and the preprocessed posture data into the feature extraction networks to extract facial expression features of the image data, time domain and frequency domain features of the physiological data and time domain and frequency domain features of the posture data;
a decision-making unit configured for sending the facial expression features, time domain and frequency domain features of the physiological data, and time domain and frequency domain features of the posture data into corresponding trained decision-making models respectively, synthesizing obtained decision-making results and the interaction log data, and judging the current learning state of the user.

5. The online learning system according to claim 4, wherein for the image data, a public expression data set is used for training to obtain an optimal convolutional neural network, and the facial expression features are reduced in data dimension by a principal component analysis to obtain effective features;
for the physiological data, a median value, a mean value, a minimum value, a maximum value, a range, a standard deviation and a variance of the physiological data are extracted as time domain features, and an average value and a standard deviation of spectrum correlation functions are extracted as low-dimensional frequency domain features, high-dimensional features are obtained by a deep belief network trained by a public data set, and the effective features are obtained by a data dimension reduction algorithm.
for the posture data, a mean value, a root mean square, a standard deviation, a moving angle and a signal amplitude vector of the posture data are extracted as the time domain features, and a direct current component of FFT is extracted as the frequency domain features, and then the effective features are obtained by the data dimension reduction algorithm.

6. The online learning system according to claim 5, wherein in the decision-making unit, a fully connected network is used as a binary decision-making model for the image data, a support vector machine is used as a binary decision-making model for the physiological data, and a hidden Markov model is used as a binary decision-making model for the posture data.

7. The online learning system according to claim 6, wherein if a weight of an image data decision is set to 0.3, a weight of a physiological data decision is set to 0.5, and a weight of a posture data decision is set to 0.2, then
R_{comprehensive}=0.3*R_{image}+0.5*R_{physiological}+0.2*Rₚₒₛₜᵤᵣₑ,
wherein R_{comprehensive} is a comprehensive decision result, R_{image} is an image data decision result, R_{physiological} is a physiological data decision result, and Rₚₒₛₜᵤᵣₑ is a posture data decision result.

8. The online learning system according to claim 1, wherein the cloud-client integration system architecture module comprises a resource coordination unit, and the resource coordination unit is configured to:
acquire utilization rates of the computing resources of the cloud server and the local client, and compare the utilization rates;
preprocess data at the local client, and then synchronize the data to the cloud server for a decision-making when a utilization rate of the computing resources of the cloud server is greater than 80% and a utilization rate of the computing resources of the local client is less than 20%;
directly synchronize original data to the cloud server, and complete the preprocessing and the decision-making for the data by the cloud server when the utilization rate of the computing resources of the local client is greater than 20%;
wherein, the utilization rate R_{utilization} of the computing resources comprises a CPU occupancy rate R_{CPU} and a memory occupancy rate R_{memory}, and is calculated by:
R_{utilization}=(R_{CPU}+R_{memory})/2*100%.

9. The online learning system according to claim 1, wherein the cloud-client integration system architecture module further comprises a visualization unit, and the visualization unit is configured to:
set up a Web server in the cloud server for the user to log in to check learning status and scoring situation of the user, and calculate a resource usage in real time by the cloud server; allow a teacher to check a learning situation of students after logging in, give scores and suggestions, and make corresponding adjustments to curriculums according to a performance of the students.

10. The online learning system according to claim 1, wherein the system interaction adjustment module comprises:
a virtual robot unit configured for selecting corresponding knowledge points from teaching materials according to a course flow, showing the knowledge points to the user in a form of pop-up dialogues, and obtaining overall performance scores of a classroom from a database, wherein the overall performance scores are divided into three grades: high, medium and low, and encouraging the user according to the overall performance scores;
a reward unit configured for ranking according to a comprehensive performance of the classroom, rewarding the students with a high ranking and encouraging the students with a low ranking, and inserting a rest and relaxation period in an original learning process or changing a learning resource difficulty for users who are relatively negative or very negative for a long time;
a curriculum adjustment unit configured for adjusting curriculums according to a learning state and an interactive feedback of the user, the learning state comprising an emotional state and a stress state, keep a course progress and materials unchanged when an emotion of the user in the online learning process is positive, a pressure level is stable, and an interaction with the online learning system is stable; and slow down a course playback speed, and replace course materials with a more detailed version when the emotion of the user in the online learning process is negative, the stress level is high, and the interaction with the online learning system is unstable.
